(19) United States
(12) Patent Application Publication
(10) Pub. No.: US 2025/0296552 A1
(43) Pub. Date: Sep. 25, 2025

(54) PARKING ASSISTANCE METHOD

(71) Applicant: TOYOTA JIDOSHA KABUSHIKI KAISHA, Aichi (JP)

(72) Inventor: Jo MORITA, Chiryu-shi (JP)

(21) Appl. No.: 19/079,464

(22) Filed: Mar. 14, 2025

(30) Foreign Application Priority Data
Mar. 21, 2024 (JP) 2024-044905

(51) Int. Cl. B60W 30/06; G05D 1/224; G05D 1/248; G05D 109/10; G05D 111/30; H04W 4/029

(52) U.S. Cl. CPC B60W 30/06; G05D 1/2246; G05D 1/248; H04W 4/029; B60W 2556/40; B60W 2556/50; G05D 2109/10; G05D 2111/30

(57) ABSTRACT

A parking assistance method includes an entry method for remotely controlling an own vehicle to park it into a parking spot and/or an exit method for remotely controlling the own vehicle to retrieve it from the parking spot by operating a portable information terminal, which is in a first state where predetermined remote operation software is activated and a predetermined first operation image is displayed, in a predetermined manner. The parking assistance method includes a second image display step of displaying a second operation image on the portable information terminal to transition the portable information terminal to the first state when the portable information terminal is located within a specific area and is in a state different from the first state.

### BACKGROUND

The present invention relates to a parking assistance method, which includes an entry method for remotely controlling an own vehicle to park it into a parking spot and/or an exit method for remotely controlling the own vehicle to retrieve it from the parking spot.

### RELATED ART

A parking assistance method has been proposed, which includes an entry method for remotely controlling an own vehicle to park it into a parking spot and/or an exit method for remotely controlling the own vehicle to retrieve it from the parking spot (for example, see Patent Document 1). In the parking assistance method disclosed in Patent Document 1 (hereinafter referred to as “the conventional method”), a portable information terminal (a smartphone or a tablet computer) is used as a device for remotely operating the own vehicle (a remote operation device). By activating predetermined remote operation software installed on the portable information terminal, a remote operation image (e.g., buttons or dials) is displayed on the terminal's display device. In this state, the user can tap or swipe the remote operation image, causing the portable information terminal to send predetermined commands to the ECU of the own vehicle via a wireless communication line. The ECU, in response to the commands, controls the drive device, braking device, and steering device of the own vehicle, allowing it to proceed along a target path.
Patent Document 1: Japanese Patent Application Laid-Open No. 2023-114501

### SUMMARY

In general, a portable information terminal has not only remote operation software but also multiple other software applications installed, which realize various functions when activated. It is conceivable that software other than the remote operation software is running in the foreground while the remote operation software is running in the background. In this case, to start remotely operating the own vehicle, the user must display the basic screen of the portable information terminal or a list of currently running software (thumbnails), locate the icon or thumbnail of the remote operation software, and tap it to activate the remote operation software in the foreground (transition to the state where the remote operation image is displayed). Such operations (preparation operations) to transition the portable information terminal to a state where the own vehicle can be remotely operated are relatively cumbersome. For example, a user holding heavy or bulky items may find such preparation operations troublesome.

One of the objects of the present invention is to provide a parking assistance method that enables the user to start remotely operating the own vehicle easily.

To solve the above problem, the parking assistance method of the present invention includes an entry method for remotely controlling an own vehicle to park it into a parking spot and/or an exit method for remotely controlling the own vehicle to retrieve it from the parking spot by operating a portable information terminal, which is in a first state where predetermined remote operation software is activated and a predetermined first operation image is displayed, in a predetermined manner. The parking assistance method includes a second image display step of displaying a second operation image on the portable information terminal to transition the portable information terminal to the first state when the portable information terminal is located within a specific area and is in a state different from the first state.

When the portable information terminal to which the present invention is applied is located within a specific area (for example, a user's home or frequently used store), the second operation image is displayed on the portable information terminal. In this state, the user can operate the portable information terminal in a predetermined manner (for example, tap the second operation image) to display the first operation image. In other words, the user can easily transition the portable information terminal to a state where the own vehicle can be remotely operated. Additionally, the second operation image is displayed only within the specific area. By setting the specific area as a region where the user is likely to perform remote operation of the own vehicle, the second operation image can be prevented from being displayed in areas other than the specific area (regions where the likelihood of performing remote operation of the own vehicle is low).

In one aspect of the parking assistance method of the present invention, the second image display step includes a first position information transmission step of acquiring, based on GPS signals, first position information representing the current location of the portable information terminal and transmitting the first position information to a predetermined server computer; a second position information transmission step of acquiring, based on GPS signals, second position information representing the current location of the own vehicle using a processor provided in the own vehicle and transmitting the second position information to the server computer; a map information transmission step of transmitting map information, which includes the first position information and the second position information, from the server computer to the portable information terminal; and a determination step of determining, based on the map information, whether the portable information terminal and the own vehicle are located within the specific area.

According to this, the portable information terminal can acquire the current location of the own vehicle via the server computer.

In another aspect of the parking assistance method of the present invention, the second image display step includes a first position information transmission step of acquiring, based on GPS signals, first position information representing the current location of the portable information terminal and transmitting the first position information to a predetermined server computer; a second position information transmission step of acquiring, based on GPS signals, second position information representing the current location of the own vehicle using a processor provided in the own vehicle and transmitting the second position information to the server computer; and an image display instruction step of causing the server computer to determine, based on the first position information and the second position information, whether the portable information terminal and the own vehicle are located within the specific area and, if they are determined to be within the specific area, transmitting an image display instruction from the server computer to the portable information terminal to display the second operation image.

According to this, the server computer executes processing to determine whether the portable information terminal and the own vehicle are located within the specific area. Therefore, compared to the case where the portable information terminal performs this processing, the processing load on the portable information terminal is reduced.

In another aspect of the parking assistance method of the present invention, the second image display step is executed on the portable information terminal when the distance between the user remotely operating the own vehicle and the own vehicle is below a threshold value.

According to this, the second operation image can be displayed only when the user is within a region where the own vehicle can be remotely operated while paying attention to the surrounding safety.

Furthermore, to solve the above problem, the parking assistance method of the present invention includes an entry method for remotely controlling an own vehicle to park it into a parking spot and/or an exit method for remotely controlling the own vehicle to retrieve it from the parking spot by operating a portable information terminal, which is in a first state where predetermined remote operation software is activated and a predetermined first operation image is displayed, in a predetermined manner. The parking assistance method includes a second image display step of displaying a second operation image on the portable information terminal to transition the portable information terminal to the first state during a specific time period when the portable information terminal is in a state different from the first state.

According to this, the second operation image is displayed on the portable information terminal during a specific time period (for example, commuting hours). In this state, the user can operate the portable information terminal in a predetermined manner (for example, tap the second operation image) to display the first image. In other words, the user can easily transition the portable information terminal to a state where the own vehicle can be remotely operated.

### BRIEF DESCRIPTION OF THE DRAWINGS

FIG. 1 is a block diagram of a parking assistance system for implementing a parking assistance method according to one embodiment of the present invention.

FIG. 2A is a plan view showing a scene where an own vehicle is parked in a parking spot by remote operation,

FIG. 2B is a plan view showing a scene where an own vehicle is exited from a parking spot by remote operation.

FIG. 3 is an example of an image used for remotely operating an own vehicle.

FIG. 4 is an example of an image used for activating the remote operation software in the foreground.

FIG. 5 is a flowchart of a program executed by the CPU of a smartphone to realize a quick start function (a function that displays the image shown in FIG. 3 on the smartphone display under specific conditions).

### DESCRIPTION OF THE EMBODIMENTS

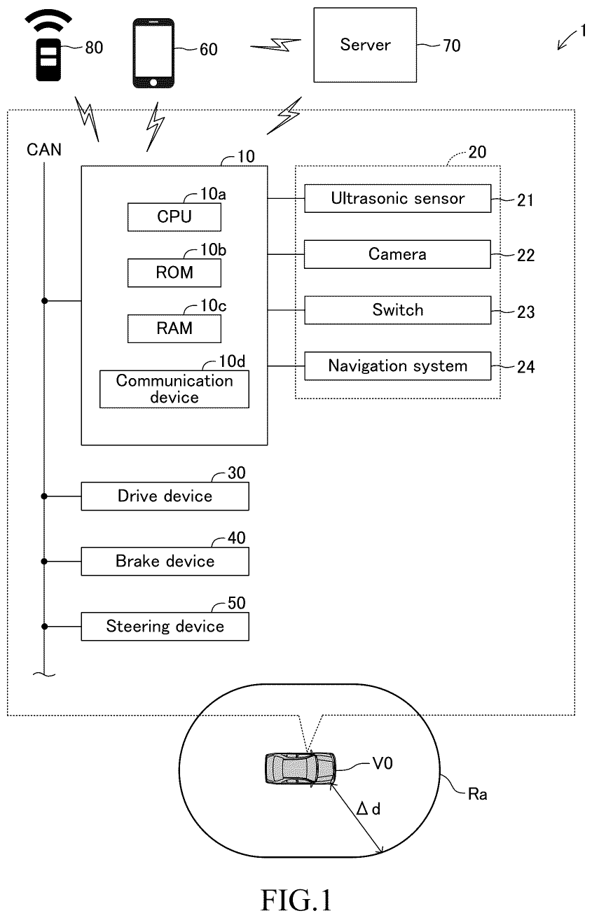

As shown in FIG. 1, a parking assistance system 1 for implementing a parking assistance method according to one embodiment of the present invention is applied to a vehicle V0 (hereinafter referred to as “the own vehicle”) equipped with an autonomous driving function. The parking assistance system 1 includes a parking assistance function that comprises an entry function for remotely operating the own vehicle to park it into a parking spot PS and an exit function for remotely operating the own vehicle to retrieve it from the parking spot PS, while the autonomous driving function is disabled (the state in which the driver is performing driving operations).

As shown in FIG. 1, the parking assistance system 1 includes an ECU 10, an in-vehicle sensor 20, a drive device 30, a braking device 40, a steering device 50, a smartphone 60, a server computer 70, and a smart key 80.

The ECU 10 is a processor installed in the own vehicle and includes a microcomputer equipped with a CPU 10a, ROM 10b, RAM 10c, and others. Additionally, the ECU 10 includes a communication device 10d for communicating with various wireless communication networks (e.g., Bluetooth or the Internet) with the smartphone 60 and a predetermined server computer 70.

The ECU 10 is connected to other ECUs (e.g., the ECUs for the drive device 30, braking device 40, steering device 50, and others) via a CAN (Controller Area Network).

The in-vehicle sensor 20 includes surrounding sensors that acquire information about objects around the own vehicle. For example, the in-vehicle sensor 20 includes ultrasonic sensors 21 and cameras 22 as surrounding sensors.

The ultrasonic sensors 21 intermittently emit ultrasonic waves into the surrounding area of the own vehicle and receive ultrasonic waves reflected by solid objects (reflected waves). Based on the time between the emission of the ultrasonic waves and the reception of the reflected waves, the ultrasonic sensors 21 recognize the distance and relative position (direction) of solid objects relative to the own vehicle and send the recognition results to the ECU 10.

The cameras 22 include imaging devices and image analysis devices. The imaging devices, such as those equipped with CCD (Charge-Coupled Device) or CIS (CMOS Image Sensor) elements, are installed at the front, rear, left side, and right side of the own vehicle. These devices capture images of the surrounding area of the own vehicle at a predetermined frame rate and acquire corresponding image data. The image data are sent to the image analysis devices, which analyze the data to obtain information about objects around the own vehicle. For instance, the image analysis devices recognize parking spots based on walls, fences, or boundary lines drawn on the road surface around the own vehicle and send the recognition results to the ECU 10.

Additionally, the in-vehicle sensor 20 includes a switch 23. The switch 23 is an operation device that allows the user to request various systems to execute control for remotely operating the own vehicle to park it into the parking spot PS. The switch 23 may include, for example, a push-button type normally open switch. The ECU 10 monitors the on/off state of the switch 23.

Furthermore, the in-vehicle sensor 20 includes a navigation system 24. The navigation system 24 acquires location information VP representing the current position (longitude and latitude) of the own vehicle based on GPS signals. The navigation system 24 sends the location information VP to the ECU 10.

The drive device 30 imparts driving force to the wheels (driving wheels among the left front wheel, right front wheel, left rear wheel, and right rear wheel). The drive device 30 includes an engine ECU, an internal combustion engine, a transmission, and a drive force transmission mechanism that transmits drive force to the wheels. The internal combustion engine includes an actuator that drives a throttle valve. The engine ECU receives a target drive force value from other ECUs (e.g., ECU 10) and drives the actuator of the internal combustion engine so that the drive force generated by the internal combustion engine matches the target value. The drive force generated by the internal combustion engine is transmitted to the driving wheels via the transmission and drive force transmission mechanism.

When the vehicle to which the parking assistance system 1 is applied is a hybrid vehicle (HEV), the engine ECU can control the drive force generated by “the internal combustion engine and the electric motor” as the vehicle drive source. When the vehicle to which the parking assistance system 1 is applied is an electric vehicle (BEV), an electric motor ECU, which controls the drive force generated by “the electric motor” as the vehicle drive source, may be used instead of the engine ECU.

The braking device 40 applies braking force to the wheels (brake discs). The braking device 40 includes a brake ECU and brake calipers. The brake calipers include actuators that press brake pads against the brake discs. The brake ECU receives a target braking force value from other ECUs and drives the actuators of the brake calipers so that the braking force applied to the wheels matches the target value.

The steering device 50 controls the steering angle of the steering wheels (the left and right front wheels). The steering device 50 includes a steering ECU and a steering mechanism. The steering device 50 also includes actuators that drive the steering mechanism to change the steering angle. The steering ECU receives a target steering angle value from other ECUs and drives the actuators so that the actual steering angle matches the target value.

The smartphone 60 functions as a remote operation device for remotely controlling the own vehicle by executing a predetermined remote operation program (remote operation software). In other words, the smartphone 60 transmits a signal (progress permission signal S1) for remotely operating the own vehicle based on user operations. This signal is transmitted to the ECU 10 via a predetermined wireless communication line (e.g., Bluetooth). The smartphone 60 is equipped with GPS functionality and acquires location information SP representing its current position (longitude and latitude) based on GPS signals. The smartphone 60 transmits the location information SP sequentially to a server computer 70 via a predetermined wireless communication line (e.g., the Internet). Note that the location information SP is transmitted sequentially to the server computer 70 whether the remote operation software is running in the foreground or background.

The server computer 70 acquires location information SP and VP from the smartphone 60 and ECU 10, respectively. Additionally, the storage device of the server computer 70 stores map information MD. The map information MD includes not only data representing roads but also data representing the premises of roadside houses and stores. Based on the location information SP, VP, and the map information MD, the server computer 70 plots the current locations of the smartphone 60 and the own vehicle on the map and provides the map information MD [SP, VP] to the smartphone 60.

The smart key 80 transmits a signal (LF-band radio wave) containing a predetermined authentication code. The ECU 10 receives the signal transmitted from the smart key 80 and enables various functions (e.g., unlocking the door or activating the parking assistance function) if the authentication code in the signal matches the code pre-assigned to the own vehicle. Furthermore, the ECU 10 can detect the distance Δd between the smart key 80 (carried by the user) and the own vehicle based on the strength of the signal received from the smart key 80. The ECU 10 determines that the user is located within a region Ra where the own vehicle can be remotely operated while paying attention to surrounding safety if the distance Δd is below a threshold value Δdth.

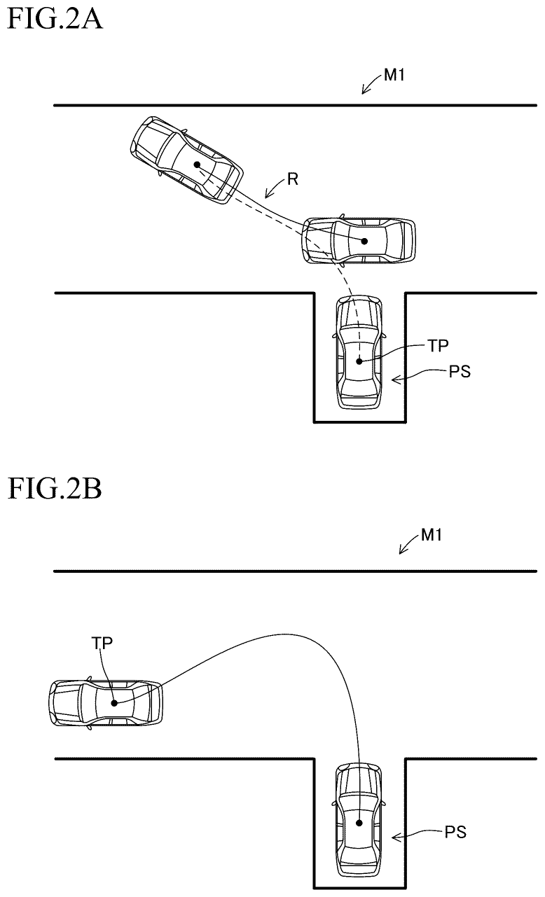

(Entry Function) The driver temporarily stops the own vehicle near the parking spot PS where they intend to park, and presses the switch 23. Upon detecting that the switch 23 has been pressed, the ECU 10 acquires information about objects around the own vehicle from the ultrasonic sensors 21 and cameras 22. Based on this information, the ECU 10 identifies parking spots where the own vehicle can be parked and obstacles in the vicinity, and generates a map M1 as shown in FIG. 2A. The map M1 is a plan view representing the position and orientation of the own vehicle relative to the parking spot PS. Note that the ECU 10 may acquire location information for parking spots where the own vehicle can be parked from the server computer 70. In this case, the server computer 70 may obtain information about the availability of parking spots from sensors (e.g., surveillance cameras) installed in the parking lot or ECUs of other vehicles located in the parking lot.

Next, based on the map M1, the ECU 10 sets a target position TP at which the own vehicle is to be parked within the parking spot PS. The target position TP is the position of the vehicle's center of gravity when the own vehicle is assumed to be parked within the parking spot PS with a predetermined space provided around it. The ECU 10 then calculates a route R (a target trajectory of the vehicle's center of gravity) to move the own vehicle to the target position TP while avoiding obstacles. The ECU 10 also sets a control signal pattern (time-series data of various target values to be supplied to the drive device 30, braking device 40, and steering device 50) for moving the own vehicle along the route R.

The ECU 10 reflects the target position TP and the route R on the map M1. The ECU 10 displays the map M1 on an onboard display (not shown). The user checks that there are no issues with the displayed route R, the target position TP, and so on.

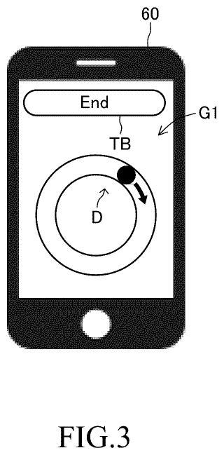

Next, the user activates the remote operation software installed on the smartphone 60 in the foreground. This establishes a wireless communication connection (e.g., Bluetooth) between the smartphone 60 and the ECU 10. Note that authentication processing (pairing) related to the connection is performed. Subsequently, the smartphone 60 displays the image G1 shown in FIG. 3 (the first operation image of the present invention). The image G1 includes a dial D used for operating the own vehicle along the route R and an end button TB for terminating the automatic parking control.

The user carries a smartphone 60 and a smart key 80, gets out of the own vehicle, and operates the smartphone 60. When the user rotates the dial D inside the area Ra (Δd≤Δdth), the smartphone 60 transmits a travel permission signal S1 indicating that the own vehicle will proceed along the route R. The travel permission signal S1 is transmitted to the ECU 10 via a wireless communication line established between the smartphone 60 and the ECU 10 or via the server computer 70. While the user rotates the dial D, the travel permission signal S1 is being transmitted. When the user stops rotating the dial D, the travel permission signal S1 is no longer transmitted. When the ECU 10 receives the travel permission signal S1 from the smartphone 60, it controls the own vehicle according to the aforementioned control signal pattern. As a result, the own vehicle gradually proceeds along the route R. If the ECU 10 does not receive the travel permission signal S1, it temporarily stops the own vehicle. For example, when pedestrians or bicycles approach the own vehicle, the user can temporarily stop the own vehicle by halting the rotation of the dial D.

Additionally, the ECU 10 sequentially acquires recognition results of objects around the own vehicle from the ultrasonic sensors 21 and the cameras 22 while the own vehicle proceeds along the route R. If the ECU 10 detects an obstacle hindering the travel of the own vehicle based on the recognition results, it temporarily stops the own vehicle. In such cases, the ECU 10 displays an image indicating the presence of an obstacle on the smartphone 60. In this situation, the ECU 10 cannot receive the travel permission signal S1. Therefore, even if the user operates the dial D, the own vehicle will not proceed. When the obstacle moves away, allowing the own vehicle to proceed, the ECU 10 can receive the travel permission signal S1 again. If the obstacle does not move and the situation where the own vehicle cannot proceed along the route R continues for a duration exceeding a threshold, the ECU 10 determines whether a new route R can be set to avoid the obstacle and reach the target position TP. If a new route R can be set, the ECU 10 temporarily displays the new route R on the smartphone 60. Then, the ECU 10 can receive the travel permission signal S1. The user can make the own vehicle proceed along the new route R by operating the dial D. The rotation direction of the dial D (clockwise or counterclockwise) is not restricted. In other words, whether the user rotates the dial D clockwise or counterclockwise, the ECU 10 progresses the control of the driving equipment according to the control signal pattern.

When the ECU 10 determines that the own vehicle has reached the target position TP, it stops the own vehicle. Furthermore, the ECU 10 shifts the gear position to the parking position, activates the parking brake, and then transitions the ignition switch to the off state. In this manner, the own vehicle is parked in the parking spot PS by remote operation.

(Exit Function) While the own vehicle is parked (with the ignition switch in the off state), the user can transition the ignition switch of the own vehicle from the off state to the on state by operating the smartphone 60 within the area Ra (for example, by rotating the dial D). Next, as shown in FIG. 2B, the ECU 10 sets a target position TP where the own vehicle can temporarily stop within the vicinity of the parking spot PS based on the information obtained from the in-vehicle sensors 20, and sets a route R leading to the target position TP. Thereafter, the ECU 10 executes processing similar to that during entry. That is, the ECU 10 performs control (exit control) to make the own vehicle proceed along the route R in accordance with the manner of remote operation (travel permission signal) by the user via the smartphone 60. When the ECU 10 determines that the own vehicle has reached the target position TP, it temporarily stops the own vehicle.

The parking support system 1 terminates the control of the own vehicle according to the control signal pattern when a predetermined termination condition is satisfied during the remote operation of the own vehicle. For example, the termination condition is satisfied when the user taps the termination button TB. Additionally, the termination condition is satisfied when the user gets into the own vehicle and starts driving operations. Furthermore, the termination condition is satisfied when the communication between the ECU 10 and the smartphone 60 is interrupted for a duration exceeding a threshold while the user is not operating the smartphone 60.

(Quick Start Function) As described above, in general, multiple software applications other than remote operation software may be installed on the smartphone 60. When the remote operation software is running in the background, the user needs to perform operations (preparation operations) to transition the smartphone 60 to a state where the remote operation software is running in the foreground (a state where the own vehicle can be remotely operated, as shown in FIG. 3). However, the user may find these preparation operations troublesome. Therefore, the parking assistance system 1 includes the following quick start function to simplify these preparation operations.

When the remote operation software is running in the background on the smartphone 60, the smartphone 60 sequentially transmits location information SP to the server computer 70. Each time the server computer 70 receives location information SP from the smartphone 60, it also obtains location information VP from the ECU 10. Based on the location information SP, VP, and the map information MD, the server computer 70 generates map information MD [SP, VP], which represents a map with the current locations of the own vehicle and the smartphone 60 plotted, and transmits it to the smartphone 60. Additionally, the ECU 10 determines whether the user is located within region Ra (a region where the user can remotely operate the own vehicle while paying attention to surrounding safety) based on the strength of the signal received from the smart key 80 and transmits the determination result to the smartphone 60.

Based on the information obtained from the server computer 70, the smartphone 60 determines whether conditions X and Y are satisfied.

Condition X: The user and the own vehicle are located within region Rb. Condition Y: The user is located within region Ra.

Here, region Rb is a region specified in advance by the user. For example, the user may set a frequently visited store as region Rb. Note that the remote operation software includes a feature (configuration software) to set region Rb. When this configuration software is activated, the smartphone 60 acquires map information MD from the server computer 70 and displays a map based on this information. The user can specify a desired region on this map (e.g., the premises of a store) as region Rb. The smartphone 60 stores information identifying region Rb (e.g., multiple coordinates representing the corners of the premises).

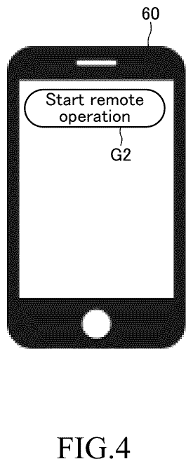

If the smartphone 60 determines that both condition X and condition Y are satisfied, it displays the image G2 (the second operation image of the present invention) shown in FIG. 4. When the smartphone 60 detects that image G2 has been tapped, it activates the remote operation software in the foreground. In other words, the smartphone 60 transitions to a state where the remote operation image G1 is displayed (the first state of the present invention).

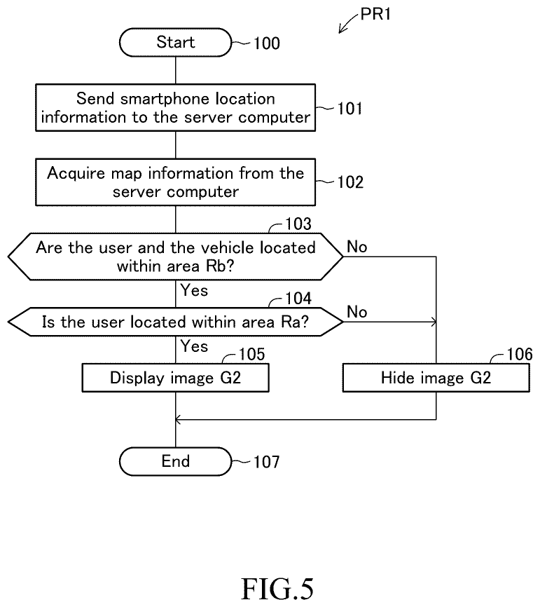

Next, with reference to FIG. 5, the processing executed by the CPU of the smartphone 60 (hereinafter referred to simply as “the CPU”) to realize the above-described quick start function will be specifically described. This processing corresponds to one of the programs (program PR1) constituting the remote operation software.

When the remote operation software is running in the background, the CPU executes program PR1 at a predetermined cycle. The CPU starts the execution of program PR1 at step 100 and proceeds to step 101.
At step 101, the CPU acquires location information SP representing the current location of the smartphone 60 based on GPS signals and transmits the location information SP to the server computer 70. The CPU then advances to step 102.
At step 102, the CPU acquires map information MD [SP, VP], which includes the current locations of the smartphone 60 and the own vehicle plotted on a map, from the server computer 70. The CPU then proceeds to step 103.
At step 103, the CPU determines, based on map information MD [SP, VP], whether the user and the own vehicle are located within the specific region Rb (condition X). If the CPU determines that condition X is satisfied (103: Yes), it proceeds to step 104. If the CPU determines that condition X is not satisfied (103: No), it proceeds to step 106.
At step 104, the CPU acquires from the ECU 10 the determination result regarding whether the user is located within region Ra (condition Y). If the CPU acquires a determination result indicating that condition Y is satisfied (104: Yes), it proceeds to step 105. If the CPU does not acquire a determination result indicating that condition Y is satisfied (104: No), it proceeds to step 106.
At step 105, the CPU displays the image G2 on the display device of the smartphone 60 and proceeds to step 107, where the execution of program PR1 is terminated.
At step 106, the CPU does not display the image G2 on the display device of the smartphone 60 and proceeds to step 107, where the execution of program PR1 is terminated. Note that if image G2 is being displayed when the CPU advances to step 106, the CPU deletes image G2.

(Effects) The smartphone 60 displays image G2 when both the user and the own vehicle are located within the specific region Rb, and the user is located within region Ra. By tapping image G2, the user can display image G1. In other words, the user can easily transition the smartphone 60 to a state where the own vehicle can be remotely operated. Additionally, image G2 is displayed only within the specific region Rb. By setting the specific region Rb as a region where the user is highly likely to remotely operate the own vehicle, the display of image G2 in areas outside region Rb (regions where the likelihood of remotely operating the own vehicle is low) can be prevented.
<Modification Example 1> In the above embodiment, the smartphone 60 displays image G2 when conditions X and Y are satisfied. Alternatively, the smartphone 60 may display image G2 when conditions Z and Y are satisfied.
Condition Z: The current time falls within a specific time period T.
For example, the user may set a commuting time period as the specific time period T.
<Modification Example 2> The map information MD may include information identifying the areas occupied by buildings (residences, stores, etc.) and parking lots. In this case, the map information MD may also include location information for building entrances. For instance, in a scene where the own vehicle is remotely operated to exit a parking spot, the smartphone 60 may display image G2 when the user is located near the building entrance (a specific region Rb1), and the own vehicle is located in a parking lot adjacent to the building (a specific region Rb2).
<Modification Example 3> The server computer 70 may acquire and store configuration information for the specific region Rb from the smartphone 60. In this case, the server computer 70 may determine, based on location information SP, location information VP, and the configuration information for region Rb, that the user and the own vehicle are located within region Rb, and transmit an instruction (push notification) to display image G2 to the smartphone 60.

What is claimed is:

1. A parking assistance method comprising:
a method for parking an own vehicle into a parking spot and/or retrieving the own vehicle from the parking spot by remotely controlling the own vehicle using a portable information terminal, which is in a first state where predetermined remote operation software is activated and a predetermined first operation image is displayed,
wherein the parking assistance method includes a second image display step of displaying a second operation image on the portable information terminal to transition the portable information terminal to the first state when the portable information terminal is located within a specific area and is in a state different from the first state.

2. The parking assistance method according to claim 1,
wherein the second image display step includes:
a first position information transmission step of acquiring first position information representing the current location of the portable information terminal based on GPS signals and transmitting the first position information to a predetermined server computer;
a second position information transmission step of acquiring second position information representing the current location of the own vehicle based on GPS signals using a processor provided in the own vehicle and transmitting the second position information to the server computer;
a map information transmission step of transmitting map information, which includes the first position information and the second position information, from the server computer to the portable information terminal; and
a determination step of determining, based on the map information, whether the portable information terminal and the own vehicle are located within the specific area.

3. The parking assistance method according to claim 1,
wherein the second image display step includes:
a first position information transmission step of acquiring first position information representing the current location of the portable information terminal based on GPS signals and transmitting the first position information to a predetermined server computer;
a second position information transmission step of acquiring second position information representing the current location of the own vehicle based on GPS signals using a processor provided in the own vehicle and transmitting the second position information to the server computer; and
an image display instruction step of transmitting an instruction from the server computer to the portable information terminal to display the second operation image,
the instruction being transmitted when the server computer determines, based on the first position information and the second position information, that the portable information terminal and the own vehicle are located within the specific area.

4. The parking assistance method according to claim 1,
wherein the second image display step is executed on the portable information terminal when the distance between the user remotely operating the own vehicle and the own vehicle is below a threshold value.

5. A parking assistance method comprising:
a method for remotely controlling an own vehicle using a portable information terminal,
which is in a first state where predetermined remote operation software is activated and a predetermined first operation image is displayed,
to park the own vehicle into a parking spot and/or to retrieve the own vehicle from the parking spot,
wherein the parking assistance method includes a second image display step of displaying a second operation image on the portable information terminal to transition the portable information terminal to the first state during a specific time period when the portable information terminal is in a state different from the first state.
